(19) United States
(12) Patent Application Publication
(10) Pub. No.: US 2016/0163407 A1
(43) Pub. Date: Jun. 9, 2016

(54) ROBUST RAMSEY SEQUENCES WITH RAMAN ADIABATIC RAPID PASSAGE

(71) Applicant: THE CHARLES STARK DRAPER LABORATORY, INC., Cambridge, MA (US)

(72) Inventors: Krish Kotru, Boston, MA (US); Justin M. Brown, Cambridge, MA (US); David L. Butts, Boston, MA (US); Joseph M. Kinast, Arlington, MA (US); Richard E. Stoner, Framingham, MA (US)

(21) Appl. No.: 14/958,525

(22) Filed: Dec. 3, 2015

Related U.S. Application Data
(60) Provisional application No. 62/086,813, filed on Dec. 3, 2014.

(51) Int. Cl. G21K 1/00; G04F 5/14

(52) U.S. Cl. CPC G21K 1/006; G04F 5/14

(57) ABSTRACT

Methods and apparatus provide for inertial sensing and atomic time-keeping based on atom interferometry. According to one example a method for inertial sensing includes trapping and cooling a cloud of atoms, applying a first beam splitter pulse sequence to the cloud of atoms, applying a mirror sequence to the cloud of atoms subsequent to applying the first beam splitter pulse sequence, applying a second beam splitter pulse sequence to the cloud of atoms subsequent to applying the mirror sequence, modulating at least one of a phase and an intensity of at least one of the first and the second beam splitter pulse sequences, performing at least one measurement subsequent to applying the second beam splitter pulse on the cloud of atoms during an interrogation time, and generating a control signal based on the at least one measurement.

### CROSS REFERENCE TO RELATED APPLICATIONS

This application claims priority under 35 U.S.C. §119(e) to U.S. Provisional Application Ser. No. 62/086,813 titled “ROBUST RAMSEY SEQUENCES WITH RAMAN ADIABATIC RAPID PASSAGE,” filed Dec. 3, 2014, which is incorporated herein by reference in its entirety.

This application is related to commonly owned, co-pending U.S. Provisional Application Ser. No. 62/086,946 titled “ATOM INTERFEROMETRY IN DYNAMIC ENVIRONMENTS,” filed Dec. 3, 2014, which is incorporated herein by reference in its entirety.

### BACKGROUND

Atom interferometry provides a useful tool for precision measurements in geodesy, inertial navigation, and fundamental physics. In light-pulse atom interferometers, stimulated Raman transitions commonly provide the atom optics that coherently split, reflect, and recombine atom wavepackets. U.S. Pat. No. 5,274,231 and U.S. Pat. No. 5,274,232, each of which is herein incorporated by reference in its entirety, disclose examples of methods and apparatus for manipulating quantum objects, such as atoms, using stimulated Raman transitions. The conventional Raman beamsplitter implementation, which uses resonant pulses to drive atomic transitions, is sensitive to variations in the intensity and difference frequency of the Raman optical fields. These variations can be minimized in a laboratory setting, but will be unavoidably larger in dynamic environments, degrading the performance of practical sensors. In addition, Raman pulses are limited in the thermal velocity range of atoms that can be effectively addressed.

Adiabatic rapid passage (ARP; also known as adiabatic fast passage (AFP)) is a technique used in nuclear magnetic resonance (NMR) to produce rotation of the macroscopic magnetization vector by shifting the frequency of radio frequency (RF) energy pulses (or the strength of the magnetic field) through resonance (the Larmor frequency) in a time that is short compared to the relaxation times. Rather than applying an RF tipping field of fixed orientation and magnitude orthogonal to the holding magnetic field, a field of variable direction is initially applied parallel to an initial polarization and swept into the desired orientation. The polarization is “dragged” while preserving its relative orientation angle with the RF field if the sweep occurs on a timescale much longer than a period of precession about the RF field. One method of varying the RF tipping field direction is by sweeping the RF frequency, as discussed, for example, in U.S. Pat. No. 4,695,799. U.S. Pat. No. 4,695,799 discloses various frequency sweep regimens in the context of NMR.

An optical beamsplitter method using adiabatic rapid passage is discussed in Atomic interferometer based on adiabatic population transfer, Weitz et al., Phys. Rev. Lett. Vol. 73, pp 2563-2566 (1994), and in Precision atom interferometry with light pulses, B. Young et al., in Atom Interferometry, ed. P. Berman (Academic Press, 1996), p. 363. In this method, a pair of laser beams with a fixed laser frequency difference, but having variable laser beam power, was used to achieve atomic population transfer.

### SUMMARY

According to one embodiment, a method for inertial sensing is provided. The method comprises trapping and cooling a cloud of atoms to a predetermined temperature, applying a first beam splitter pulse sequence to the cloud of atoms, after a first predetermined dwell time, applying a mirror sequence to the cloud of atoms subsequent to applying the first beam splitter pulse sequence, after a second predetermined dwell time, applying a second beam splitter pulse sequence to the cloud of atoms subsequent to applying the mirror sequence, modulating at least one of a phase and an intensity of at least one of the first and the second beam splitter pulse sequences, performing at least one measurement subsequent to applying the second beam splitter pulse on the cloud of atoms during an interrogation time, and generating a control signal based on the at least one measurement.

According to one example, at least one of the first and the second beam splitter pulse sequences is a π/2 adiabatic rapid passage (ARP) pulse sequence. According to another example, the mirror sequence is a π ARP sequence.

According to some examples, modulating includes nonlinear modulation of the phase. According to at least one example, the at least one measurement is a measured transition probability. According to another example, the at least one measurement is a fractional frequency measurement. According to some example, at least one of the first and the second predetermined dwell times is at least ten π pulse durations. According to a further example, at least one of the first and the second predetermined dwell times is 26 π pulse durations. According to one example, the interrogation time is in a range from 1 to 17 ms.

According to another embodiment, a method for inducing momentum transfer is provided. The method comprises trapping and cooling an atom cloud including a plurality of atoms, applying a sequence of adiabatic rapid passage (ARP) light pulses to the plurality of atoms to induce momentum transfer, the sequence including: applying a first π/2 ARP sweep, after a first dwell time subsequent to the first π/2 ARP sweep, applying a mirror π ARP sweep, and after a second dwell time subsequent to the mirror π ARP sweep, applying a second π/2 ARP sweep, modulating at least one of a phase and an intensity of at least one of the first and the second π/2 ARP sweeps, performing at least one measurement associated with induced momentum transfer of the atom cloud, and generating a control signal based on the at least one measurement.

According to one example, the at least one measurement includes measuring at least one of an acceleration and a rotation of at least a portion of the plurality of atoms forming the atom cloud.

According to another embodiment, an atom interferometer is provided. The atom interferometer comprises an atom cloud including a plurality of atoms, a trap configured to trap and cool the plurality of atoms to a predetermined temperature and launch the plurality of atoms into an interferometry region, at least one laser light source disposed adjacent to the interferometry region and configured to apply a sequence of adiabatic rapid passage (ARP) light pulses to the interferometry region, an electro-optic modulator coupled to the at least one laser light source and configured to sweep a Raman detuning frequency of the light pulses, an amplifier coupled to the at least one laser light source and configured to modulate an optical intensity of the at least one laser light source, and a controller coupled to the at least one laser light source, the electro-optic modulator, and the amplifier and configured to: direct the sequence of ARP light pulses at the atom cloud to induce adiabatic transitions between internal quantum levels of at least a fraction of the plurality of atoms during the sequence of ARP light pulses, and obtain at least one measurement from the atom cloud based on the adiabatic transitions.

According to one example, the sequence of ARP light pulses comprises a first beam splitter pulse sequence, a mirror sequence, and a second beam splitter pulse sequence, the first beam splitter pulse sequence, the mirror sequence, and the second beam splitter pulse sequence temporally separated from one another by a dwell time, and the controller is further configured to control the timing of the sequence of ARP light pulses. According to one example, the controller is configured to obtain the at least one measurement by determining a fraction of atoms in each internal quantum level.

According to some examples, the atom interferometer further comprises an arbitrary waveform generator coupled to the electro-optic modulator and is configured to generate a phase waveform. According to another example, the atom interferometer further comprises a linear translation stage coupled to the at least one laser light source and configured to move the at least one laser light source in relation to the cloud of atoms in the interferometry region.

According to one example, the at least one laser light source comprises counter-propagating beams of light directed at the atom cloud. According to some examples, each beam of light is collimated to a 1/e² intensity diameter of 7.1 mm.

According to another example, the sequence of ARP light pulses includes a first beam splitter pulse sequence and a second beam splitter pulse sequence temporally separated from one another by a dwell time. According to some examples, the controller is further configured to generate a clock signal based on the at least one measurement. According to another example, the at least one laser light source comprises co-propagating beams of light.

According to another embodiment, a method for atomic time-keeping is provided. The method comprises trapping and cooling a cloud of atoms to a predetermined temperature, applying a first beam splitter pulse sequence to the cloud of atoms, after a first predetermined dwell time, applying a second beam splitter pulse sequence to the cloud of atoms subsequent to applying the first beam splitter pulse sequence, modulating at least one of a phase and an intensity of at least one of the first and the second beam splitter pulse sequences, performing at least one measurement on the cloud of atoms during an interrogation time following the second beam splitter pulse sequence, and generating a clock signal based on the at least one measurement.

In one example, at least one of the first and the second beam splitter pulse sequences is a π/2 adiabatic rapid passage (ARP) pulse sequence. According to some examples, the trapped and cooled cloud of atoms are in a first clock state and the at least one measurement includes determining a fraction of atoms in the first clock state and a fraction of atoms in a second clock state.

According to another embodiment, an atomic clock device is provided. The atomic clock device comprises an atom cloud including a plurality of atoms, a trap configured to trap and cool the plurality of atoms to a predetermined temperature and launch the plurality of atoms into an interferometry region, at least one laser light source disposed adjacent to the interferometry region and configured to apply a sequence of adiabatic rapid passage (ARP) light pulses to the interferometry region, an electro-optic modulator coupled to the at least one laser light source and configured to sweep a Raman detuning frequency of the light pulses, an amplifier coupled to the at least one laser light source and configured to modulate an optical intensity of the at least one laser light source, and a controller coupled to the at least one laser light source, the electro-optic modulator, and the amplifier and configured to: direct the sequence of ARP light pulses at the atom cloud to induce adiabatic transitions between internal quantum levels of at least a fraction of the plurality of atoms during the sequence of ARP light pulses, and obtain at least one measurement from the atom cloud based on the adiabatic transitions.

According to one example, the at least one laser light source comprises co-propagating beams of light directed at the atom cloud. According to another example, the at least one laser light source comprises a pair of co-propagating laser light sources. In some examples, the clock signal achieves an Allan deviation of about 3.5×10−12 at τ=2500 seconds for measurements acquired at 1.6 Hz. According to another example, the sequence of ARP light pulses includes a first beam splitter pulse sequence and a second beam splitter pulse sequence temporally separated from one another by a dwell time. According to another example, the controller is further configured to generate a clock signal based on the at least one measurement.

Still other aspects, embodiments, and advantages of these example aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Embodiments disclosed herein may be combined with other embodiments, and references to “an embodiment,” “an example,” “some embodiments,” “some examples,” “an alternate embodiment,” “various embodiments,” “one embodiment,” “at least one embodiment,” “this and other embodiments,” “certain embodiments,” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a diagram schematically illustrating a Bloch sphere depiction of Raman adiabatic rapid passage according to aspects of the invention;

FIGS. 2A-2D are a series of diagrams schematically illustrating a Raman ARP Ramsey sequence on a Bloch sphere according to aspects of the invention;

FIG. 3A is a graph illustrating time evolution of transition probability (representing population transfer) during a Raman ARP sweep according to aspects of the invention;

FIG. 3B is graph illustrating transition probability as a function of the center frequency sweep using the same sweep parameters as FIG. 3A;

FIG. 4 is a diagram schematically illustrating movement of a polarization on the Bloch sphere caused by rotating the effective drive field according to aspects of the invention;

FIG. 5 is a diagram further schematically illustrating that rotation of the effective drive field produces efficient coherent transfer of atomic population from one ground state to another, according to aspects of the invention;

FIG. 6 is a diagram schematically illustrating a combiner frequency sweep in which rotation of the effective drive field causes polarization movement on the Bloch sphere according to aspects of the invention;

FIG. 7A is a diagram schematically illustrating an RCAP beamsplitter frequency sweep applied to an atomic coherence, according to aspects of the invention;

FIG. 7B is a diagram schematically illustrating a phase reversal combiner frequency sweep applied to the polarization produced by the beamsplitter sweep of FIG. 7A, according to aspects of the invention;

FIG. 8 is a series of graphs illustrating examples of Ramsey fringes based on Raman π/2 pulses and Raman ARP beamsplitters with two different sweep durations;

FIG. 9A is diagram schematically illustrating an octagonal glass vacuum chamber and laser beam configuration for atom trapping, state preparation, and interferometry according to aspects of the invention;

FIG. 9B is a diagram schematically illustrating the intermediate excited states for a stimulated Raman process according to aspects of the invention;

FIGS. 10A-10C are a series of graphs illustrating a series of measurements of two-pulse Ramsey sequence phase shifts for Raman pulse and ARP interrogations according to aspects of the invention;

FIG. 11A is a graph illustrating the contrast response of three types of Ramsey sequences to AC Stark shifts according to aspects of the invention;

FIG. 11B is a graph illustrating the variations in background offset of three types of Ramsey sequences to AC Stark shifts according to aspects of the invention;

FIG. 12 is a graph illustrating the contrast variation due to laser beam intensity gradients for three types of Ramsey sequences according to aspects of the invention;

FIG. 13 is a graph illustrating the phase sensitivity of Raman ARP Ramsey sequence to 10% variations in parameters defining the ARP frequency sweep;

FIG. 14A is a graph illustrating the Allan deviations of fractional frequency measurements acquired with three interleaved pulse types according to aspects of the invention;

FIG. 14B is a graph illustrating the Allan deviations of fractional frequency measurements acquired at a higher data rate than in FIG. 14A; and

FIG. 15 is a flow diagram of at least one example of a method according to aspects of the invention.

### DETAILED DESCRIPTION

Stable atomic frequency references are essential to a broad range of modern technologies, including the Global Positioning System, inertial navigators, distributed networks, and laboratory instruments. The introduction of the chip-scale atomic clock (CSAC) further enhances the functionality of these references. CSACs probe narrow atomic resonances derived from coherent population trapping (CPT) of alkali-metal atoms in minute vapor cells. For example, in a 10-cm³ package, and with a power consumption at 100 mW, CSACs can provide a fractional frequency stability of 2.5×10⁻¹⁰/\sqrt{τ}. However, the long-term stability of CSACs is limited to ˜10⁻¹¹ at 1000 seconds (s) by buffer gas-dependent frequency shifts. As a result, CSACs typically serve as secondary frequency references. Typical primary references that use laboratory-scale systems also suffer from certain deficiencies, including fractional frequency uncertainties of 3×10⁻⁶. These clocks can achieve greater sensitivity at the expense of size and data rate. For example, higher sensitivity can be achieved by launching laser-cooled alkali-metal atoms over 1 meter (m) distances and implementing microwave Ramsey sequences with long interrogation times. There is thus a need for a primary standard that is capable of operating in a compact volume and dynamic environments located outside a laboratory setting.

Typically, high sensitivity in fountain clocks can be traded for reduced size by shortening the Ramsey dwell time and interrogating atoms in the cooling and trapping region (i.e., carrying out both atom trapping and interrogation in the same volume). In dynamic environments, a short Ramsey time may have the added benefit of reducing unconstrained motion of the atom cloud. For example, if measurements are completed on a 10 ms time scale, then a cold atom cloud experiencing 1-10-g accelerations is displaced from the trap site by <5 mm, which enables recapture of cold atoms and fast data rates with narrow laser beams. Methods of using microwaves for the Ramsey interrogation typically requires well-engineered cavities or waveguides, which constrain the minimum size obtainable and are adversely affected by thermal environments or vibrations. Alternative approaches that circumvent the use of a cavity include optical interrogation, but these methods introduce separate challenges from microwave interrogation, such as phase errors caused by AC Stark shifts and spatially dependent Rabi rates caused by the Gaussian intensity profile of the laser beam. CPT timekeeping systems using optical fields have been shown to achieve a fractional frequency uncertainty of 2×10⁻¹² at 1000 s, with certain magnetic-field instabilities.

Aspects and embodiments are directed to methods and systems for optical Ramsey interrogation that suppresses sensitivity to light shifts and Rabi rate inhomogeneities. The disclosed approach uses atom optics that are based on Raman adiabatic rapid passage (ARP), which may also be referred to herein as Raman chirped adiabatic passage (RCAP), which is inspired by, and isomorphic to the adiabatic rapid passage techniques used in nuclear magnetic resonance (NMR) spectroscopy. According to various aspects, ARP is less sensitive to thermal and spatial distribution of atoms. In ARP, a slow sweep of the radio frequency (RF) frequency preserves the initial angle between the drive field and magnetization vector, thereby allowing efficient population inversion and production of coherences. An atom subject to coherent laser beam pairs is analogous to a classical magnetization subjected to an RF magnetic field of fixed frequency. In this case, the fixed frequency corresponds to the frequency different between the coherent laser beams in the par. Accordingly, a Raman pulse can be considered as an RF field of constant frequency effectively torqueing the classical magnetization about its axis.

In NMR, ARP inverts the population in a two-level system by slowly sweeping the angular frequency of a rotating magnetic field through the Rabi resonance. In the frame of the time-dependent field, the nuclear spin precesses about the effective magnetic field with a latitude that slowly tilts from the north to the south pole. As discussed further below, the Raman ARP approach used herein uses an analogous sweep of the frequency difference of the Raman optical fields through the two-photon resonance. ARP may impart smaller phase errors and may address broader thermal velocity distributions than conventional pulsed techniques for atom interferometry. In addition, RCAP may permit implementation of atom interferometer inertial sensors of improved ability to accommodate highly dynamic environments. Typical beamsplitter techniques using fixed-frequency Raman pulses are sensitive to Doppler-induced detunings that can produce phase errors in dynamic environments. In addition, a primary purpose of a Raman pulse is to accurately imprint the laser phase on the phase of the atomic coherence, and if the pulse is applied off resonance, substantial phase errors may result. This sensitivity may be avoided by using RCAP in lieu of a standard Raman pulse beamsplitter. Specifically, phase errors caused by AC Stark shifts may be greatly reduced by use of RCAP. Raman ARP reduces the phase sensitivity of a Ramsey sequence to the differential AC Stark shift because the first beamsplitter does not imprint a relative phase on the quantum state in the adiabatic limit. ARP is also robust to intensity variations, since transfer efficiency is not a strong function of Rabi rate. Thus, interferometer contrast is preserved in the presence of intensity fluctuations and gradients, and the phase is insensitive to small changes in frequency sweep parameters, as discussed further below.

Stimulated Raman adiabatic passage (STIRAP) includes applying two resonant Raman beams with separate time-varying intensities to achieve varying orientation of the effective “RF field.” Thus, adiabatic transfer in a three-level system results from time-delayed intensity modulations of two optical fields. However, variation of intensity poses significant control and stability problems. Raman ARP differs from STIRAP, and frequency-swept ARP has at least two advantages over STIRAP: (1) in a Ramsey sequence, spontaneous emission during the second STRAP pulse reduces the maximum interferometer contrast by approximately a factor of 2, and (2) the presence of multiple excited levels in alkali-metal atoms reintroduces residual Stark shifts to STIRAP, with dependencies on pulse duration, optical intensity, and single-photon laser detuning. In fact, precision control of laser power (intensity) is far more difficult than precision control of other parameters, such as laser frequency. Raman ARP atom optics according to various embodiments may provide many of the benefits afforded by varied laser intensity, but with fewer drawbacks.

As discussed further below, efficient population inversion and Ramsey interferometry can be achieved based on Raman ARP. Further, Raman ARP may be used to suppress phase deviations due to AC Stark shifts by about two orders of magnitude, compared to fixed-frequency Raman transitions, and Gaussian spatial intensity distribution of the Raman beam induced fractional variations in contrast can be reduced by a factor of 15 for Raman ARP compared to standard Raman transitions. In addition, deliberate perturbations to frequency sweep parameters do not introduce resolvable shifts in phase. The Raman ARP systems and methods disclosed herein may achieve a fractional frequency uncertainty of 3.5×10⁻¹² after 2500 s of averaging.

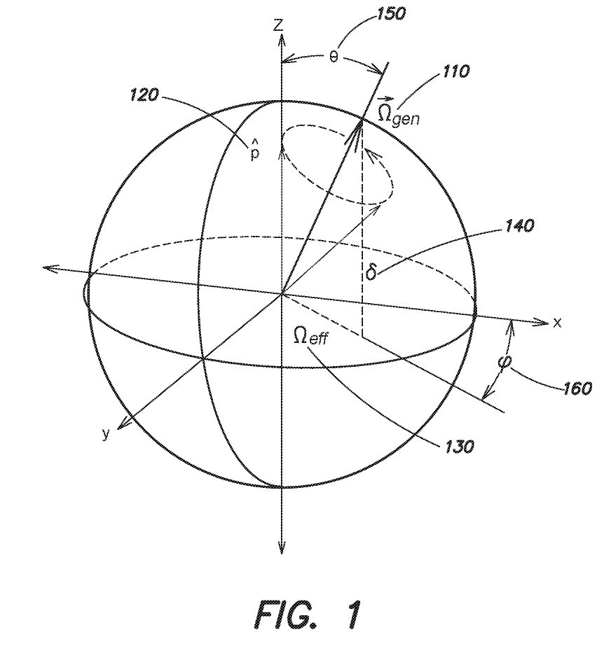

Frequency-swept ARP may be used for robust population inversion in NMR, and its effect on a two-state system can be visualized on the Bloch sphere shown in FIG. 1. The pseudospin polarization \hat{p} 120 represents a superposition of “spin-up” and “spin-down” states corresponding to |F=4, m_{F}=0 [symbol] and |F=3, m_{F}=0 [symbol] states, respectively. The generalized Rabi rate \vec{Ω}_{gen} 110 represents the Raman pulse “drive field” and is analogous to the effective magnetic field in the NMR system. When the drive field is applied, \hat{p} 120 precesses about \vec{Ω}_{gen} 110 at the generalized Rabi frequency Ω_{gen}=\vec{Ω_{eff}²+δ²}, where Ω 130 is the magnitude of the two-photon Rabi rate, and δ=ω₁−ω₂−ω_{HFS} (140) is the Raman detuning, and precession can be expressed as \dot{p}=\vec{Ω}_{gen}×\hat{p} (also expressed as Equation (3) below). The polar angle 150 of the drive field is θ=−arctan (Ω_{eff}/δ). The azimuthal angle φ 160 represents the phase difference between the two Raman frequency components. If the drive field undergoes a polar angle rotation at a rate \dot{θ}<<Ω_{gen}, \hat{p} 120 encircles \vec{Ω}_{gen} 110 before θ 150 changes appreciably. As a result, rapid precession causes \hat{p} 120 to adiabatically follow Ω_{gen} 110. The projection of \hat{p} 120 onto the drive field, which is defined as \vec{p}∥, can thus be dragged anywhere on the Bloch sphere. Experimentally, the polar angle θ 150 is controlled by sweeping the detuning δ 140 through resonance, over a frequency range that is large in comparison to Ω_{eff} 130. According to certain aspects, the two-state model is appropriate because the single photon detuning Δ satisfies Δ>>Ω_{eff} This parameter regime allows for adiabatic elimination of all intermediary excited states in the 6²P_{3/2} manifold.

ARP is generally advantageous when inversion is required in the presence of an inhomogeneous drive field. Since the Rabi rate in this case is position dependent, precise control of spin precession cannot be achieved simultaneously over the entire ensemble. As a result, fixed-frequency π and π/2 pulses tend to over- or undershoot the desired pulse area for a given atom. With an ARP sweep, however, transfer efficiency in the adiabatic limit ultimately depends on the projection of \hat{p} onto \vec{Ω}_{gen}, namely \vec{p}∥, which is independent of precession. In the typical approach to ARP, δ(t) is linearly chirped through resonance. According to various embodiments disclosed herein, a nonlinear sweep (i.e., using laser beam pairs in which the frequency difference is swept over time, otherwise referred to as frequency sweeps) is instead performed that rapidly changes the polar angle θ at the beginning and end of the adiabatic passage, when the adiabatic condition, i.e., the tipping rate is much slower than the rate of precession, is well satisfied. The optical intensity may also be reduced near the beginning and end of the sweep. A short sweep minimizes dephasing attributed to spontaneous emission. The frequency sweep used herein is expressed below by Equation (1):

$$δ ( t ) = {Ω}_{arp} tan [ α ( \frac{2 t}{{T}_{π}} ) - 1 ] , \\ t ∈ \{ 0 , {T}_{π} \} \qquad Equation ( 1 )$$

where
T_{π} sets the total sweep duration, (the first sweep parameter),
Ωₐᵣₚ controls the sweep rate without perturbing its duration or range, i.e., defines the shape of the ARP frequency sweep (the second sweep parameter), and
α=arctan(δₘₐₓ/Ωₐᵣₚ), where δₘₐₓ is the maximum detuning (the third sweep parameter).

To quantify the adiabaticity of a particular sweep, a unitless parameter Q(t) is defined where Q(t)=Ωgen/|\dot{θ}|. Near resonance, and when δₘₐₓ>>Ω_{eff}=Ωₐᵣₚ, Q is equivalent to T_{π} in units of Raman π pulses. In other words, Q=n, when T_{π}=nt_{π}, where t_{π} is the duration of a Raman π pulse. According to various aspects, Q≧5 provides sufficient adiabaticity for robust population transfer. According to other aspects, sweeps may begin or end near resonance (when Q is minimized), and Q may have a value of 10 or 26. The frequency sweep described by Equation (1) is coupled with an intensity modulation I(t), which is expressed below by Equation (2):

$$I ( t ) = {I}_{0} tanh [ β ( 1 - \vert \frac{2 t}{{T}_{π}} - 1 \vert ) ] \qquad Equation ( 2 )$$

where
I₀ is the maximum intensity, and
β is a unitless parameter having a typical value of 7.5.
Since I(0)=I(T_{π})=0, the drive field at the beginning and end of the sweep is essentially parallel with the z axis of the Bloch sphere. This alignment helps maximize transfer efficiency when atoms are prepared in one of the clock states.

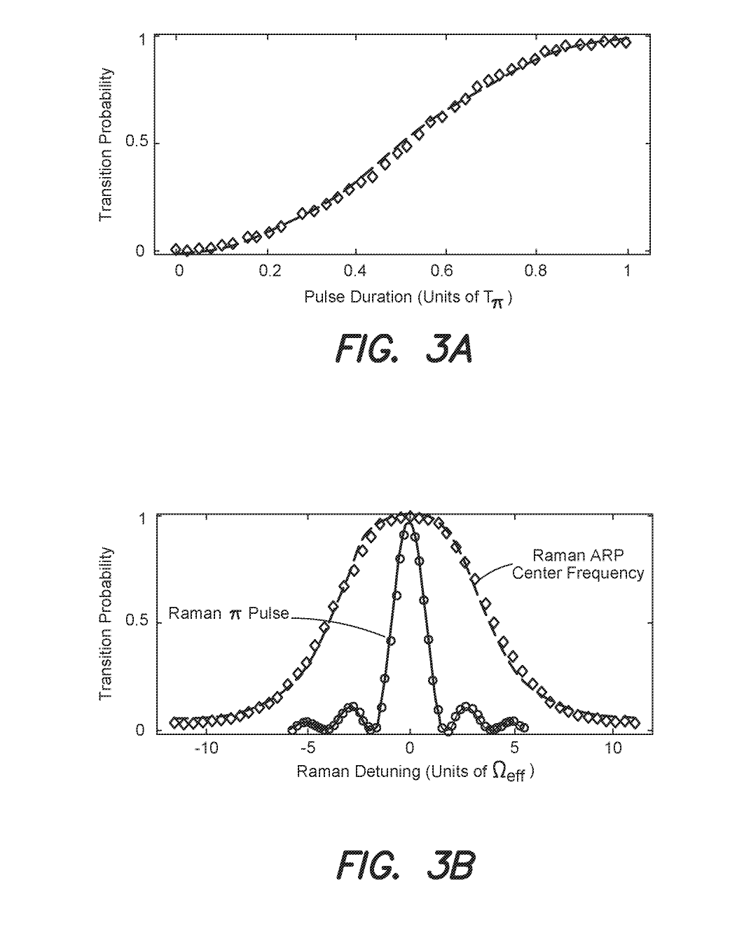

FIG. 3A shows the ensemble-averaged time evolution of the transition probability during this tangent sweep, i.e., the Raman ARP sweep described by Equations (1) and (2). The sweep parameters were T_{π}=10.3t_{π}, δₘₐₓ/2π=15 MHz, and Ωₐᵣₚ/2π=Ω_{eff}/2π=86 kHz. For Ω_{eff}=Ωₐᵣₚ, the measured transition probabilities follow the sinusoid predicted by a model described in further detail below. Measurements of the transition probability as a function of the center frequency of the sweep (using the same sweep parameters as in FIG. 3A) are shown in FIG. 3B and reveal a full width at half maximum value of 8Ω_{eff}, which is about five times broader than the corresponding bandwidth of a Raman π pulse. Near resonance, the coherent transfer efficiency is limited to 93% by spontaneous emission.

The predictions plotted in FIGS. 3A and 3B were based on a model of a two-level atom. The dynamics of this system, viewed in reference to the Bloch sphere shown in FIG. 1, are expressed below by Equation (3):

$$\frac{d \hat{p}}{d t} = {\vec{Ω}}_{gen} \times \hat{p} \qquad Equation ( 3 )$$

With a set of initial conditions for the drive field and the pseudospin polarization, the model numerically integrates Equation (3). Numerical integration is necessary because Raman ARP frequency sweeps introduce time dependencies to \vec{Ω}_{gen} that generally impede analytic solutions. Interferometer sequences can be modeled by incorporating a period of free precession about the z axis of the Bloch sphere during the time between two pulses. Following a pulse sequence, the model reports the atom transition probability in response to a varied parameter, such as Raman detuning or phase. The model is also capable of accounting for ensemble effects by repeating the calculation for many atoms with randomly assigned positions and velocities, making Ω_{eff} a Gaussian function of position, and averaging over the resulting transition probabilities. In accordance with certain aspects, the model used herein does not include ensemble averaging effects.

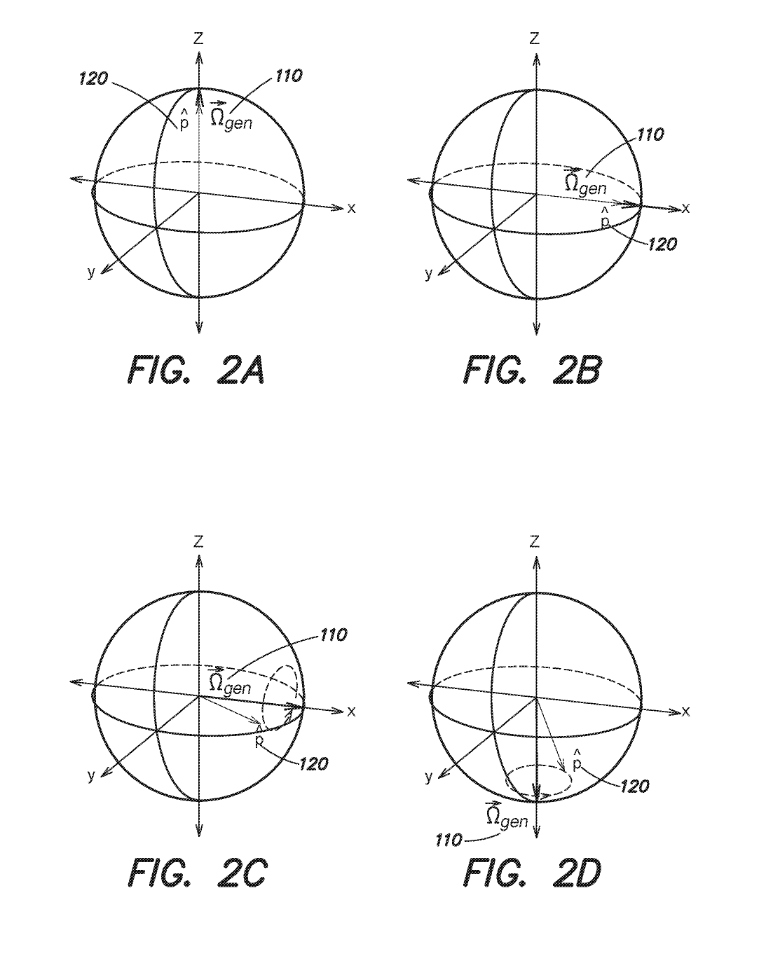

Ramsey sequences are commonly viewed as atom interferometers comprising two π/2 pulses, or beamsplitters, separated by an interrogation time T. An atom beamsplitter divides the atomic wave packet in two, with the resulting partial wave packets assuming different hyperfine and momentum states. In practice, the co-propagating Raman optical fields may impart a negligible momentum kick. A Ramsey sequence derived from these beamsplitters is then primarily an atom interferometer for the internal hyperfine states of the atom. Raman ARP serves as an effective beamsplitter for a Ramsey atom interferometer when the sweep is stopped midway, at the Raman resonance. In FIG. 2A, the first Ramsey pulse begins with \vec{Ω}_{gen} 110 and \hat{p} 120 initially parallel after state preparation. The drive field 110 then slowly drags the pseudospin 120 into the x-y plane (see FIG. 2B) creating a coherent superposition of the clock states. Thus, the first sweep transfers the pseudospin polarization into the x-y plane when its center frequency matches the Raman resonance condition. After an interrogation time T, a second beamsplitter starts nearly on resonance to complete the Ramsey sequence. At the beginning of this pulse, \vec{Ω}_{gen} 110 and \hat{p} 120 are generally nonparallel, because of discrepancies between the oscillator and atomic resonance frequencies—which the atomic reference is intended to correct. The misalignment leads to the precession of \hat{p} 120 about \vec{Ω}_{gen} 110, as shown in FIG. 2C. The drive field 110 (second beamsplitter) then drags \vec{p}∥ to the z axis (see FIG. 2D) thereby converting the interferometer phase, i.e., the relative phase between the drive field and pseudospin polarization, into population difference.

In ARP, a slow sweep of the radio frequency (RF) frequency preserves the initial angle between the drive field and magnetization vector, thereby allowing efficient population inversion and production of coherences. An atom subject to coherent laser beam pairs is analogous to a classical magnetization subjected to an RF magnetic field of fixed frequency. In this case, the fixed frequency corresponds to the frequency difference between the coherent laser beams in the pair. Accordingly, a Raman pulse can be considered as an RF field of constant frequency effectively torqueing the classical magnetization about its axis.

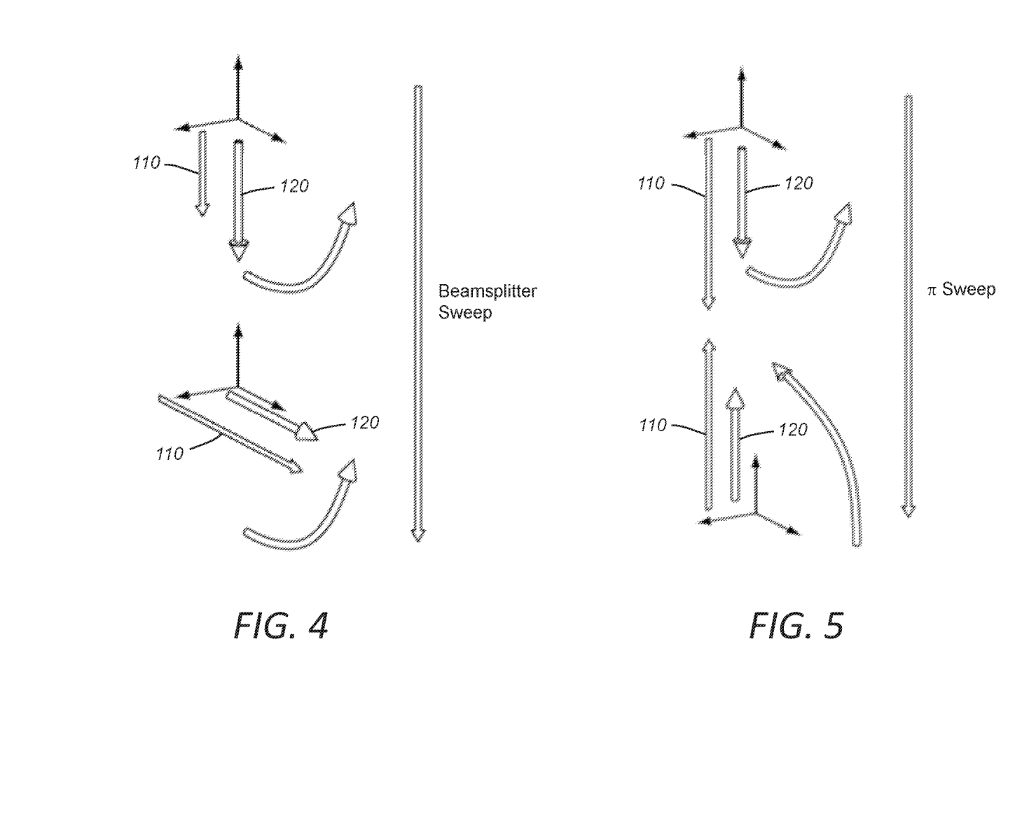

Referring to FIGS. 4-7B, various types of sweeps may be used in atom interferometers, and may be useful in ARP. For instance, beamsplitter, inversion, combiner, and mirror sweeps, as discussed further below, may be combined together or with standard Raman pulses to implement a variety of different configurations depending on the application. Furthermore, the intensity of the Raman lasers may be systematically varied during the sweeps described below to improve efficiency.

Referring to FIG. 4, and applying the NMR analogy to the atom, at the start of a frequency sweep, the effective drive field 110 is aligned with the initial polarization 120 of the atomic system, which is analogous to FIG. 2A discussed above. As the effective drive field 110 rotates (changes orientation on the Bloch sphere as a result of the time-varying frequency difference), the polarization 120 follows the effective drive field, and as also shown in FIG. 2B. The drive field may be turned off in the equatorial plane, resulting in an atomic beamsplitter.

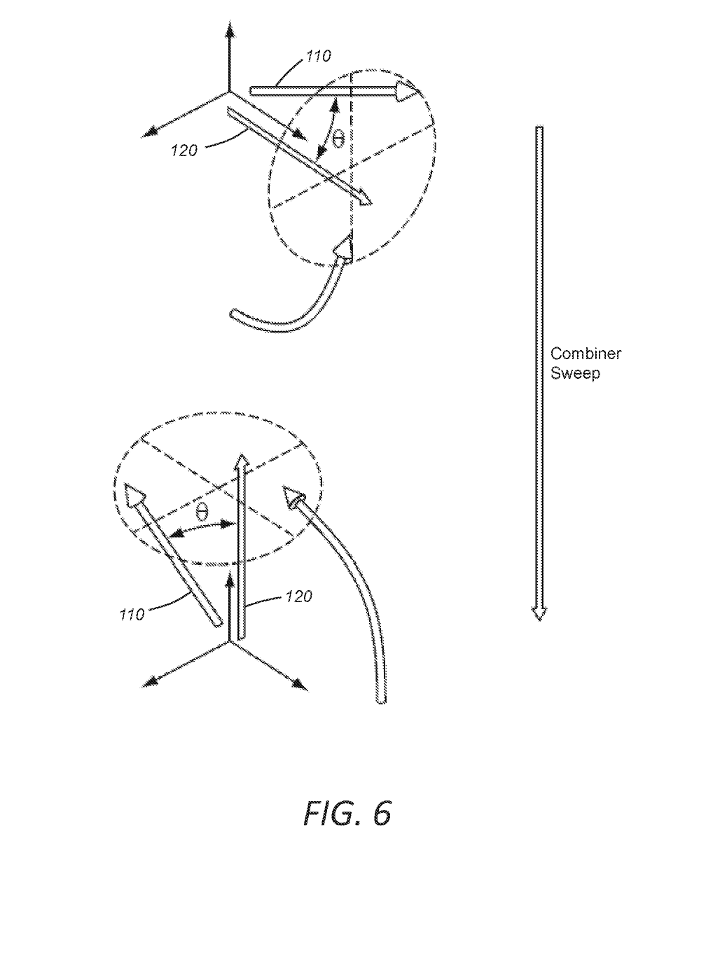

FIG. 5 illustrates how the sweep of FIG. 4 can be continued to the opposite pole, thus comprising an inversion sweep that produces efficient coherent transfer of atomic population from one ground state to another.

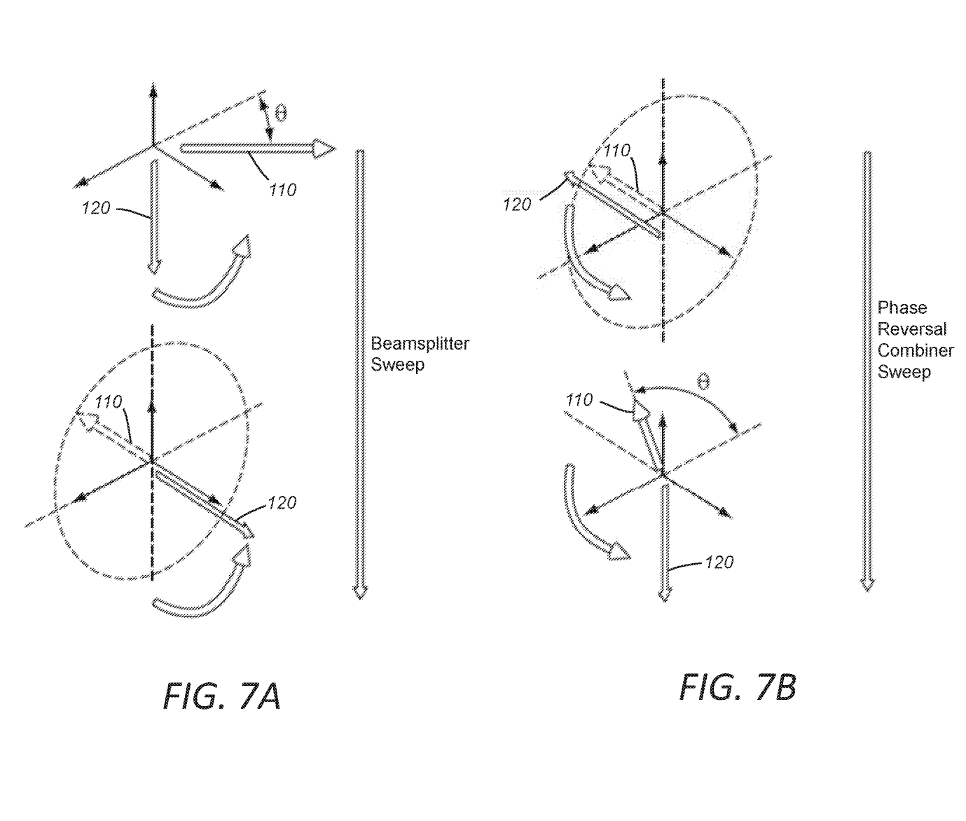

FIG. 6 illustrates a combiner sweep, which is analogous to the inverse of the beamsplitter shown in FIG. 4 and FIG. 2B. In a combiner sweep, the effective drive field 110 is initially on the equatorial plane of the Bloch sphere, at an angle θ with a polarization 120 that is also oriented in the equatorial plane. As the effective drive field 110 rotates, the polarization 120 precesses about the drive field, but their relative angle of orientation θ is preserved. When the drive field 110 rotates to polar orientation, the polarization 120 is oriented at an angle θ with respect to the pole. Measuring the atom's relative ground state population thus reveals the relative phase of the initial polarization with respect to the initial effective drive field.

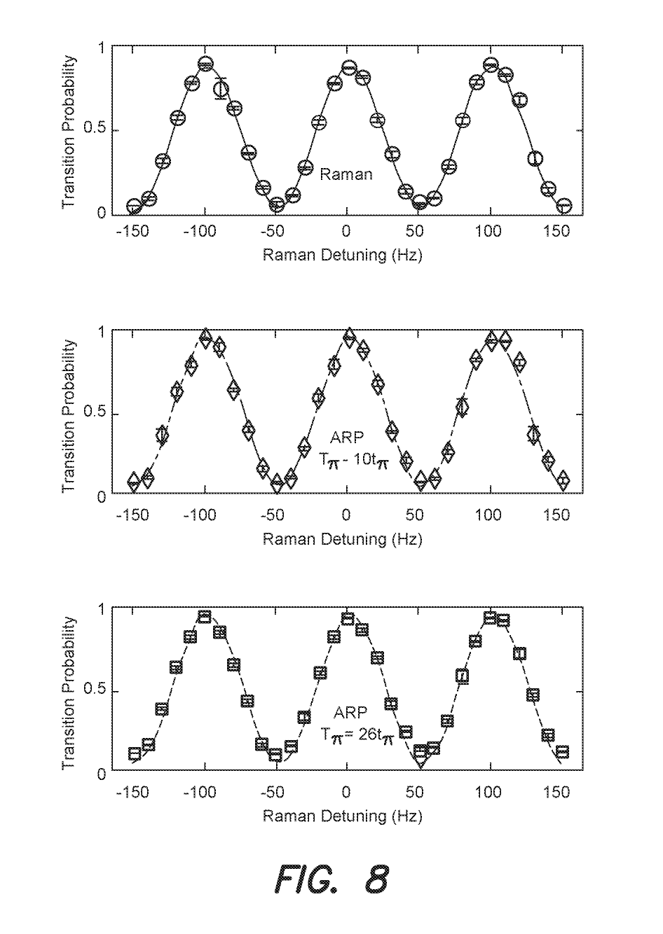

FIGS. 7A and 7B illustrate a sequence of two concatenated sweeps which taken together will be referred to as a mirror sweep. A mirror sweep is analogous to a paired combination of the beamsplitter and combiner, or inverse of the beamsplitter, discussed above. FIG. 7A illustrates application of an effective drive field 110 initially in a polar orientation, to a polarization 120 oriented in the equatorial plane at an angle θ with respect to the axis of rotation of the drive field. The drive field rotates into the equatorial plane. The polarization precesses about the drive field at a rate proportional to the drive field strength, and ends up in the plane normal to the drive field and containing the drive field rotation axis (i.e., the beamsplitter sweep). The orientation of the polarization 120 in that plane is determined by the effective drive field strength and the duration of the sweep. The phase of the drive field 110 is then incremented by π, as depicted in FIG. 7B, and swept back to its original polar orientation. The field strength and sweep duration are substantially the same as those used in the first sweep. The polarization thus precesses through the same angle about the drive field 110 as during the first sweep, but in the opposite sense, so that its final orientation is in the equatorial plane at the angle θ with respect to the axis of orientation as shown (i.e., the phase reversal combiner sweep). Thus, the polarization 120 has been “mirrored” in the equatorial plane with respect to the polarization axis of rotation.

In certain instances, use of a far off resonant laser source for the tipping field permits implementation of either a mirror sweep or a standard Raman mirror pulse in interferometer applications. There is presently no mechanism for implementing a mirror function with STRAP, and as a result, STRAP-only interferometers realize reduced interferometer contrast as compared to RCAP or Raman-based interferometers.

Referring back to FIGS. 2A-2D, rapid completion of the pulse sequence depicted in FIGS. 2A-2D may be beneficial for a device operating in a dynamic environment. A short measurement sequence ensures that an atom cloud experiencing large transverse acceleration forces remains within the Raman laser beam during the Ramsey interrogation. It also enables averaging of noise processes to lower levels in shorter times, which enhances short-term sensitivity. For example, an interrogation time of T=10 ms, coupled with a sampling rate of f_{S}=80 Hz, and a phase signal-to-noise ratio of SNR_{φ}=200, results in a fractional frequency stability as expressed below by Equation (4):

$$\frac{1 / SNR φ}{{ω}_{HFS} T \sqrt{{f}_{S}}} \qquad Equation ( 4 )$$

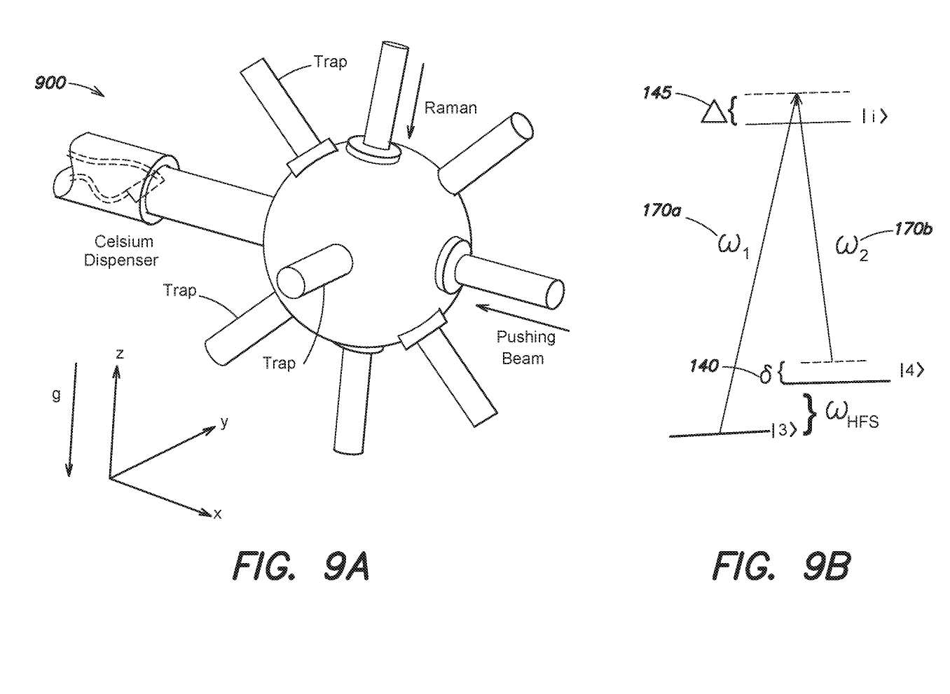

having a value of ≈1×10⁻¹² for an averaging time of 1 s. In addition, the cloud remains within the 1/e² intensity radius of the Raman beam for transverse accelerations up to 5 g. FIG. 8 shows examples of Ramsey fringes based on Raman π/2 pulses and Raman ARP beamsplitters with T_{π}=10t_{π} and 26t_{π}, where t_{π}=π/Ω_{eff} is the duration of a resonant Raman π pulse. The results shown in FIG. 8 used an experimental set-up as discussed further below. The interrogation time T was 10 ms, the magnitude of the two-photon Rabi rate was Ω_{eff}/2π=73 kHz, and the ARP sweep parameters were δₘₐₓ/2π=15 MHz and Ωₐᵣₚ/2π=73 kHz. To reduce discrepancies arising from oscillator drifts and environmental magnetic fields, the three pulse types were applied sequentially at a given detuning, and measurements were collected at 1.6 Hz over 10 min. The measurements were fit to a cosine function according to Equation (5) below:

$$P = \frac{1}{2} + \frac{A}{2} cos [ ( δ - {δ}_{0} ) T ] + B \qquad Equation ( 5 )$$

where P is the measured transition probability, i.e., the normalized atom count, and free parameters such as contrast A, background offset B, and Raman detuning offset δ₀, are determined through minimization of the sum of squares of the residuals. For both the Raman π/2 and T_{π}=26t_{π} cases, the fit uncertainty in δ₀/2π was ±0.24 Hz, which indicated similar short-term stability.

As noted herein, Raman ARP Ramsey sequences are insensitive to dynamic phase associated with pseudospin precession in the adiabatic limit. The source of dynamic phase can be attributed to the dressed-atom model, which models the modification of the energy level structures of a two-level atom when it interacts with a laser field, and is further explained in Fractional adiabatic passage in two-level systems: Mirrors and beam splitters for atomic interferometry, Bateman et al., Phys. Rev. A Vol. 76, 013416 (Jul. 24, 2007). Eigenstates in this model are parallel and antiparallel to \vec{Ω}_{gen}, with eigenenergies of ±Ω_{gen}/2. When Ω_{gen} is varied adiabatically, a dressed eigenstate acquires a phase

$$γ = \pm {\int }_{0}^{t} {Ω}_{gen} ( {t}^{′} ) d {t}^{′} / 2 ,$$

in a manner analogous to the evolution of eigenstates in a time-independent system. During the first ARP beamsplitter, \hat{p} is the dressed eigenstate parallel to \vec{Ω}_{gen}, so adiabatic evolution introduces an undetectable overall phase γ₁. For subsequent pulses, however, \vec{Ω}_{gen} and \hat{p} are typically nonparallel (i.e., see FIG. 2C). The state is therefore a superposition of dressed eigenstates, which acquire differential phases ±γ₂ during the sweep. The two-pulse Ramsey sequence is insensitive to this relative dynamic phase, because γ2 remains a phase prior to state readout. Thus, interferometers involving more than two beamsplitters map dynamic phases to population difference if subsequent ARP sweeps do not cancel them (e.g., by reversing the direction of \vec{Ω}_{gen}). In such a case, inhomogeneities in Ω_{eff} and δ may diphase the ensemble and wash out interference fringes.

### EXAMPLES

The function and advantages of these and other embodiments will be more fully understood from the following examples. These examples are intended to be illustrative in nature and are not to be considered as limiting the scope of the systems and methods discussed herein. The following examples demonstrate atom interferometry with Raman chirped adiabatic passage sweeps using the apparatus described below.

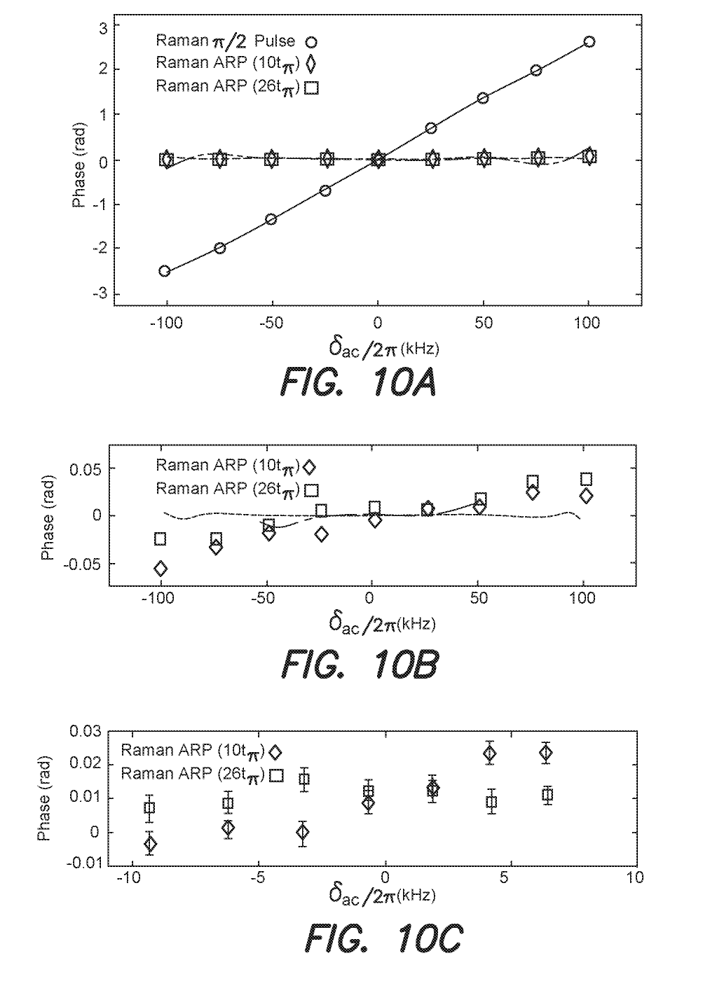

In particular, the interferometry experiments were conducted using D2 line cesium 133 atoms and were conducted inside an octagonal 80-cm³ machined-quartz cell, having a diameter of 2.75 inches, such as the one shown at 900 in FIG. 9A, which maintained a background vapor pressure of approximately 10⁻⁹ Torr. During experiments, atoms fall through the center of the Raman beam because of its vertical orientation. Environmental magnetic fields were canceled by three orthogonal pairs of Helmholtz coils. Each measurement cycle began with the cooling and trapping of ˜10⁷ atoms in 600 ms using a magneto-optical trap (MOT). Polarization gradient cooling further cooled the cloud to 9 μK. To prepare the atoms in a single hyperfine ground state, a vertical bias field of 0.87 G was first applied to lift the Zeeman degeneracy. The atoms were then optically pumped on the |F=4 [symbol] →|F′=4 [symbol] transition (where F′ denotes a hyperfine level in the 6² P_{3/2} manifold) with light polarized linearly and parallel to the bias field until 90% of the atoms were in the |F=4, m_{F}=0 [symbol] dark state. Light resonant with the |F=3 [symbol] →|F′=4 [symbol] transition simultaneously pumped atoms out of F=3. A microwave it pulse tuned to the clock transition transferred atoms from the dark state to |F=3, m_{F}=0 [symbol] . A subsequent laser pulse, resonant with the F=4 [symbol] →|F′=5 [symbol] cycling transition, pushed atoms remaining in F=4 out of the interaction region. Interferometry began with >97% of the remaining atoms initially in the |F=3, m_{F}=0 [symbol] clock state. These atoms were interrogated in a Ramsey sequence, which comprised two atom “beamsplitters” (e.g., Raman π/2 pulses) separated by an interrogation time T that ranged from 1 to 17 ms. The final state of the interferometer consisted of atoms in superpositions of the F=3 and F=4 clock states. To extract the interferometer phase, the fraction of atoms in F=4 after laser induced fluorescence were measured. Specifically, light resonant with the |F=4 [symbol] →|F′=5) transition was applied, and the resulting fluorescence was associated with states that had collapsed to F=4. A second pulse of the same light then pushed these atoms out of the interaction region. The remaining atoms in F=3 were optically pumped to F=4 and fluoresced in a similar manner. The sum of these two fluorescence signals was proportional to the total population and the ratio of total fluorescence to fluorescence from the F=4 atoms provided a normalized readout.

The cesium clock transition (|F=3, m_{F}=0 [symbol] →|F=4, m_{F}=0)) was driven using stimulated Raman processes via intermediate excited states in the 6² P_{3/2} manifold, as shown in FIG. 9B. For example, cesium 133 atoms at ground-state levels |3 [symbol] and |4 [symbol] are coupled by a stimulated Raman transition with single-photon detuning Δ 145, Raman detuning δ 140, and optical frequencies ω₁ 170a and ω₂ 170b. The Raman optical frequencies, ω₁ and ω₂ (170a and 170b), were generated by phase modulating the output of an external cavity diode laser (100 kHz linewidth, 50 mW) with an electro-optic modulator (EOM), i.e., a phase modulator. The optical spectrum contained frequency sidebands spaced about the carrier by integer multiples of the Zeeman-shifted hyperfine splitting frequency ω_{HFS}/2π=9 192 631 770+324 Hz. To reduce spontaneous emission, the Raman laser was blue-detuned by 2.02 GHz with respect to the |F=3 [symbol] |F′=4) transition. At this detuning, the differential AC Stark shift (i.e., the difference of the AC Stark shifts of the clock states) was canceled when the optical power was ˜10% larger in the carrier frequency than in each first-order sideband. To obtain agile control over the microwave signal that drove the EOM, a single-sideband mixer (Polyphase SSB90110A) was used to combine the 30-MHz output of a 625-MS/s arbitrary waveform generator (Agilent N8241A) with a constant 9.163-GHz signal (Agilent E8257D). The phase, frequency, and power of the resulting RF signal were controlled through the waveform generator, enabling rapid frequency sweeps for Raman ARP. An acousto-optic modulator placed before the EOM switched the Raman light in 50 ns, and a tapered amplifier downstream of the EOM increased the total Raman optical power presented to the atoms to 40 mW. The optical spectrum of the tapered amplifier contained a 30-nm-wide pedestal carrying a small amount of resonant light. To reduce spontaneous emission during the interferometer, the resonant light from the pedestal was filtered by passing the output of the tapered amplifier through a Cs reference vapor cell. The Raman beam was vertically oriented, circularly polarized, and delivered to the cell using a fiber-coupled collimator with 7.1-mm 1/e² intensity diameter. The co-propagating pair of carrier and −1 sideband frequencies drove the dominant Raman transition, which was Doppler shifted by 30.7 Hz/(m/s), or 0.3 Hz/ms in a 1-g environment.

The interferometry experiments described below generally involved extracting interferograms while deliberately varying parameters like the differential AC Stark shift or the two-photon Rabi rate. To generate an interferograms, the transition probability was measured while shifting the laser phase difference between the Raman optical fields. This phase difference was scanned over 17 values in steps of π/4 rad, and the transition probability at each phase was measured five times consecutively to enable averaging. With a per-shot data rate of 1.6 Hz, a full interferograms was acquired every 53 s. To isolate slow systematic variations due to oscillator drift and environmental magnetic fields, interferograms for ARP, Raman, and microwave pulses were acquired consecutively, within 2.7 min, at a particular parameter setting. Parameters were varied nonmonotonically to further reduce contributions from slow systematic trends. Parameter values of interest were cycled through three times for additional averaging.

A cold atom frequency standard based on Ramsey sequences is likely to experience parameter fluctuations during operation outside the laboratory. In dynamic environments, variations in optical power, RF power, and atom cloud position may affect Ramsey interferograms. Examples 1-3 demonstrate how Raman ARP beamsplitters in a Ramsey sequence suppress one or more of these effects.

### Example 1

### Light Shifts During a Pulse

A Ramsey sequence based on Raman ARP affords an important advantage of Raman π/2 pulses: light shifts experienced during a pulse leave the interferometer phase unperturbed. The presence of a light shift during Raman ARP moves the center frequency of the sweep off resonance. The beamsplitter shown in FIG. 2B ends outside the x-y plane, as does the parallel pseudospin p. This error in polar angle does not affect the phase of the Ramsey interferometer, which instead depends on the azimuthal separation between \hat{p} and \vec{Ω}_{gen}. Errors in polar angle, however, do affect interferometer contrast. When the second beamsplitter is initially π rad out of phase with \hat{p}, the light shift reduces the transfer efficiency, causing the troughs of the interferograms to rise up. In certain applications where small light shifts are relevant, the resulting variations in contrast and background offset have a minor impact on sensitivity, as discussed further below.

The sensitivity of three types of Ramsey sequences to the differential AC Stark shift δ_{ac} tested: (1) Raman π/2 pulse sequences, (2) Raman ARP sequences with a sweep duration T_{π} of 10t_{π}, and (3) Raman ARP sequences with a sweep duration of 26t_{π}. The contrast A, background offset B, and systematic phase offset Φ for each interferogram were recorded. The transition probability P is related to these quantities by Equation (5) above, where the detuning dependence in the argument of the cosine function is replaced by Φ+Δφ, and Δφ is the programmed phase difference between the two Ramsey pulses. Entire interferograms were extracted to determine A, B, and Φ simultaneously, which suppressed undesirable cross-coupling effects in the measurement of P. This technique differs from another, simpler approach in which each measurement of phase is related to a single measurement of transition probability made with Δφ=π/2 and Φ≈0. In this latter approach, phase measurements are susceptible to variations in A and B since the transition probability varies with these parameters, i.e., see Equation (5).

For each AC Stark shift setting, the three types of interferometers were measured sequentially, three times over 8 minutes. To extract an interferogram, Δφ was scanned over two fringes in steps of π/4 rad, and to enable averaging, each phase condition was repeated five consecutive times. The AC Stark shift was varied by adjusting the relative optical power in the two Raman frequency components. This meant that the AC Stark shift was controlled with the modulation depth of the electro-optic modulator (EOM) in the Raman beam path, which in turn adjusted the ratio of the optical powers in each Raman frequency. In essence, the light shift δ_{ac} deliberately varied by changing the ratio of optical powers in each Raman frequency. At each setting of the modulation depth, the overall optical power was adjusted with the tapered amplifier to maintain Ω_{eff}/2π=73 kHz to within ±2%. The light shift was assumed to be the Raman detuning at which population transfer with a Raman π pulse was maximized. These calibration steps were followed by setting the oscillator frequency to the Zeeman-shifted clock resonance before interferometry commenced. Thus, the oscillator was detuned by the light shift during application of the pulse, but resonant with the atoms during the Ramsey dwell period. The short interrogation time T=1 ms suppressed the sensitivity to oscillator instabilities and helped isolate phase shifts associated with pulse dynamics.

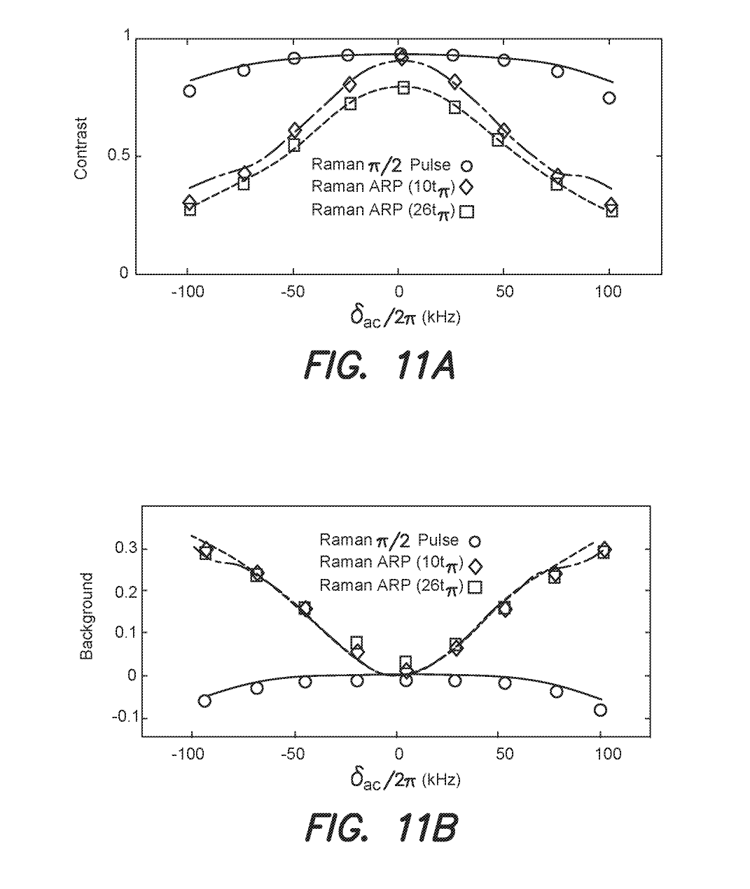

FIG. 10A is a plot of the overall systemic phase offset Φ of each interferometer as a function of δ_{ac}. The Raman π/2 pulse measurements show good agreement with the predictions from the Bloch model discussed above, reflecting an approximately linear transfer function over a range in AC Stark shifts of ±100 kHz with a slope of 26 mrad/kHz, which corresponds to the light shift sensitivity. The ARP interferometers strongly suppress this sensitivity. The results indicate that the Raman-pulse case was about 75 times more sensitive to δ_{ac} than the Raman ARP interrogations having sweep durations of 10t_{π} and 26t_{π}.

A more detailed view of the Raman ARP interrogations is shown in FIG. 10B, which plots the AC Stark induced shifts for the ARP modalities over a ±100 kHz variation of AC Stark shift. FIG. 10B indicates an overall linear trend of 0.34 mrad/kHz, with localized curvature, neither of which the Bloch model discussed above predicts. The predictions for T_{π}=10tπ are restricted to detunings where the sweep is adiabatic enough for the model to produce controlled phase shifts. The corresponding measured phases at δ_{ac}/2π=±100 kHz are not completely randomized, which may be a result of ensemble averaging effects.

The differential Stark shift with Δ≈2 GHz in practice may be restricted to ±0.02 Ω_{eff}≈±2π×1 KHz, due to ˜1% power fluctuations in the RF signal modulating the EOM. Below this bound, the measurements and stabilization of RF power may be difficult to obtain. Thus, the experiment was repeated over a narrower detuning range near δac=0. In this example, Ω_{eff} was not calibrated from one condition to the next, because the measured variation was ±2% of the nominal setting. The light shift was calibrated to the modulation depth of the EOM, which was then tracked via real-time RF power measurements Linear fits to the Raman ARP phase offsets are shown in FIG. 10C, and the Raman phase offsets (not shown) were compared to determine the relative sensitivity to δ_{ac}. The ratios of the two ARP slopes to the Raman slope were 0.063±0.008 for the 10t_{π} case and 0.0005±0.008 for the 26t_{π} case. Drifts in δ_{ac} on the order of ±0.02 Ω_{eff} are expected in a practical device, so the measured sensitivity of the Raman π/2 sequence to Sac implies that the phase will drift by 26 mrad. In the case were δ_{ac} is a white noise process, the fractional frequency stability for the example presented in Equation (4) becomes 5×10⁻¹² after 1 s of averaging, because the phase signal-to-noise ratio drops to SNR_{φ}=40. By comparison, the Raman ARP interferometer with a sweep duration of 26tπ brings the noise process due to AC Stark shifts below the atom shot noise limit for 10⁷ atoms. Thus, the results in FIG. 10C indicate that the Raman pulse case was roughly 100 times more sensitive to δ_{ac} than Raman ARP interrogations with T_{π}=26t_{π}.

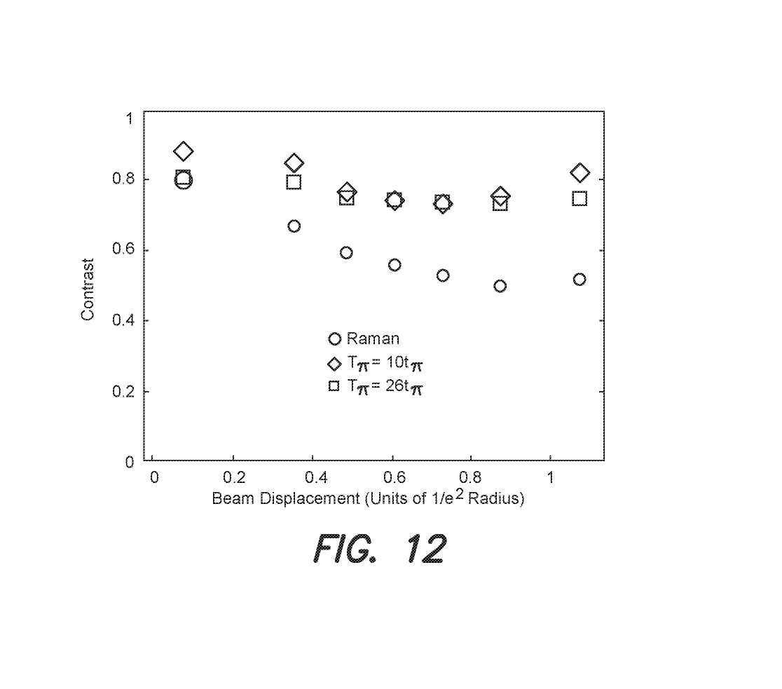

The extraction of full interferograms also enabled the study of contrast and background offset variations in response to the light shift. When phase shifts are estimated from single measurements of transition probability, made near Δφ=π/2, variations in background offset can lead to large apparent phase shifts. In contrast, small changes are inherently tolerable near Δφ=π/2, since they merely scale existing errors in transition probability, i.e., Equation (5). FIG. 11A shows the contrast response to δ_{ac} for the three pulses discussed above. In each case, the maximum measured contrast serves to normalize the associated predictions. This normalization qualitatively accounts for spontaneous emission losses during Raman ARP sweeps and yields good agreement with measurements when the sweep is adiabatic. For Raman pulses, normalization approximately accounts for dephasing due to inhomogeneities in Ω_{eff} and δ_{ac} emission makes a minor contribution). Since these inhomogeneities scale with Ω_{eff} and δ_{ac} and are coupled, it is reasonable that the Bloch model overestimates the contrast away from resonance. For small differential Stark shifts of ±0.02 Ω_{eff} (within the bounds of reasonable RF power control), the contrast is expected to vary by about 0.13% and should scale phase deviations from Δφ=±π/2 by this fraction.

Variations in background offsets follow the unmodified predictions of the model, as shown in FIG. 11B. The rise in Raman ARP offsets in response to detuning indicates that the troughs of the interferograms are pulled up due to impaired transfer efficiency during the second pulse. For Stark shifts of ±0.02 Ω_{eff}, the offset is expected to vary by about 0.07%, leading to a phase error (<2 mrad) below the expected signal-to-noise ratio of a practical system. Sensitivity to background offsets can be further suppressed by sequentially measuring transition probability near Δφ=±π/2 and estimating the phase error from the difference of consecutive measurements. Slow variations in this parameter may then be immaterial since they produce the same differential phase.

### Example 2

### Laser Beam Intensity Profile

Raman ARP also achieves a high degree of robustness against optical intensity variations. Since the projection of the pseudospin polarization onto the drive field \vec{p}∥ is unaffected by Ω_{eff} in the adiabatic limit, Ramsey sequences based on Raman ARP maintain high contrast despite fluctuations in optical power or poor beam quality. One cause of power variation in dynamic and mobile platforms is the motion of the atom cloud along the beam radius. For example, during a T=10 ms interrogation, a cloud accelerating transverse to the beam axis at 3.5 g traverses the 1σ radius of a Gaussian beam with a 7-mm 1/e² intensity diameter. Over this difference, the beam profile introduces substantial position-dependent changes to the gradient and average of the optical intensity experienced by the cloud. A practical timing reference may measure such accelerations using an inertial sensor. With a T=10 ms interrogation time, a low-performance accelerometer with a 10-mg resolution can determine the radial position of the cloud to within 5 microns. Such accurate position information, along with knowledge of the beam profile, enables compensation for changes in the average intensity via modification of optical power or pulse duration.

The effect of the intensity gradient on interferometer contrast was tested by displacing the Raman beam relative to the atom cloud and using pulse duration to compensate for changes in the average intensity. Specifically, pulse durations at each position were corrected such that t_{π}=π/Ω_{eff}. During real transverse accelerations, the first Ramsey pulse occurs with the cloud near the beam center, while the second Ramsey pulse occurs with the cloud closer to the beam edge, where the gradients are larger. In this experiment however, Raman beam position was kept constant for a given experimental condition, which meant that both pulses imposed detrimental intensity gradients.

To control the radial position of the cloud within the beam, the Raman beam collimator was mounted to a linear translation stage. This changed the intensity gradient since the Raman beam (with a Gaussian intensity profile) could be displaced relative to the atom cloud. Prior to the experiment, the beam was centered on the cloud by maximizing Ω_{eff} with a fixed optical intensity, and then minimizing decoherence during Rabi flopping experiments. Ω_{eff} and δ_{ac} were extracted at each position from measurements of the Raman π pulse resonance as a function of detuning (e.g., FIG. 3B), and the differential AC Stark shift was reduced to |δ_{ac}|≦0.02Ω_{eff}. The ARP sweeps were adjusted to maintain Ωₐᵣₚ=Ω_{eff} so that in units of t_{π}, the frequency profile remained the same. Interferometry was then carried out using Raman π/2 pulses and Raman ARP pulses with sweep durations of 10tπ and 26tπ. A realistic interrogation time of 10 ms captured contrast loss associated with cloud expansion.

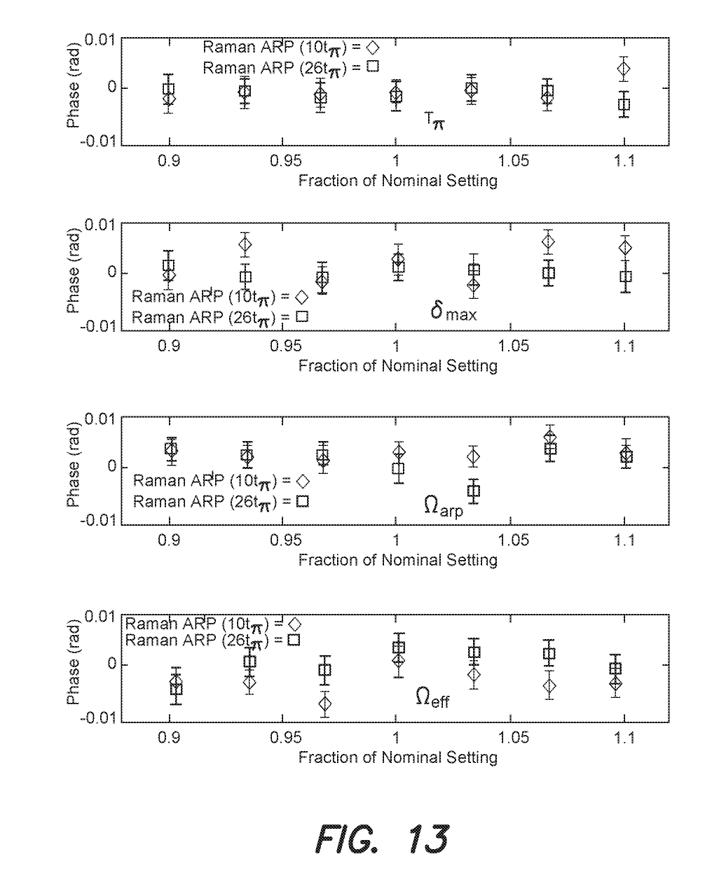

FIG. 12 shows that over a 26 range of the beam radius, the fractional variation in contrast is three times smaller for ARP sweeps than for resonant Raman pulses. While the contrast of the 10tπ ARP interferometer still trends with the beam position, the more adiabatic 26tπ ARP interferometer exhibits a 1.5% contrast variation out to half the 1/e² intensity radius. Thus, over the e^{-1/2} intensity radius, the fractional variation in contrast was 15 times larger for Raman π/2 pulses than for Raman ARP with T_{π}=26t_{π}. This robustness may help improve the stability of clock interferometers that operate in dynamic environments without the need for larger beam diameters and higher optical power.

### Example 3

### Sweep Parameters

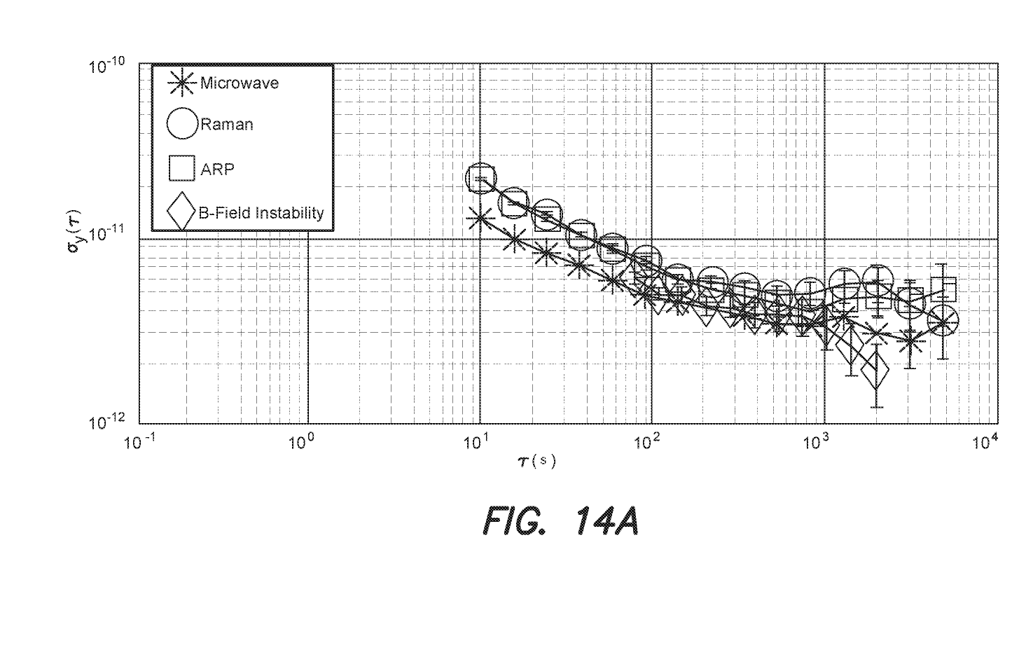

Parameter fluctuations in practical frequency sweeps may introduce instabilities to a Raman ARP-based clock. Variations in Ω_{eff} may arise from drifts in optical power, polarization, and RF power, whereas perturbations to the sweep parameters T_{π}, Ωₐᵣₚ, and δₘₐₓ may result from reproducibility issues associated with broad frequency sweeps in RF systems. To provide a robust timing reference, a Raman ARP Ramsey sequence should be capable of withstanding reasonable variations in these parameters. The simple Bloch model predicted <1 mrad phase deviations and contrast variations consistent with zero in response to ±10% changes in the sweep parameters listed above. The sensitivity was tested by extracting ARP interferograms with T=1 ms interrogation times, while adjusting the sweep parameters over ±10% of a nominal value, as described above. For each parameter, Raman ARP interferograms were acquired for sweep durations of 10tπ and 26tπ. The phase responses are plotted in FIG. 13, and represent weighted averages, with error bars signifying standard errors. Long-term stability was limited by second-order Zeeman shift resulting from the 870-mG bias filed. At about 4×10⁻¹¹, the fractional frequency uncertainty of the disclosed open-loop clock (meaning that the interferometers were operated with a it/2 phase shift applied to the second pulse, which results in the population transfer taking on a value near the interferograms mean value) was consistent with the <3 mrad phase uncertainty seen in this particular experiment, given a T=1-ms interrogation time.

Due to spontaneous emission, the contrast responded linearly to changes in the sweep duration T_{π} and Ω_{eff}. The 26t_{π} and 10t_{π} cases exhibited maximum contrast deviations of 3.8% and 1.8%, respectively. The maximum respective deviations in background offset were 0.7% and 0.4%. The resulting 0.07% instability in offset yields a fractional frequency stability at 1 s of 3×10⁻¹³. These effects may be further suppressed by averaging of sequential phase measurements at Δφ=±π/2.

By scanning the single-photon Raman laser detuning, spontaneous emission reached a broad minimum between 2 and 3.5 GHz. The magnitude of the detuning scan was bounded by the hyperfine splitting frequency to enable the cancellation of light shifts through the correct choice of optical intensity ratios.

### Example 4

### Stability Assessment

Allan deviations were computed for Ramsey frequency measurements based on Raman ARP pulses with sweep durations of 26t_{π}, as well as Raman π/2 pulses and microwave π/2 pulses. The bias field was reduced to a value of 87 mG to suppress contributions from environmental magnetic fields. The clock state Zeeman shift has a quadratic dependence on field strength, so drifts in the magnetic environments act in conjunction with a small bias field to produce smaller systematic phase shifts. Phase deviations were related to frequency shifts through precise knowledge of the interrogation time, which was set to T=16.667 ms to synchronize with (and thereby suppress) environmental electromagnetic noise at 60 Hz. It was noted that contrast values for the ARP and microwave interferometers were not noticeably changed by the increase in interrogation time from 10 to 16.667 ms. The three pulse types were applied sequentially with a data rate of 1.6 Hz, but the effective data rate for a particular pulse type was 0.13 Hz because frequency measurements were based on interferogram fits. Interferograms were extracted from four consecutive measurements with phase shifts of Δφ={−3π/4, −π/4, π/4, 3π/4}. This allowed for simultaneous measurements of interferometer contrast and background offset. The RF signal generator, provided with a 10-MHz reference form a separate Cs beam clock (Symmetricom 5071A), produced a stable signal that enabled examination of the long-term stability of the atomic reference. The fractional frequency stability of the Cs beam reference is 5×10⁻¹²/\sqrt{τ}.

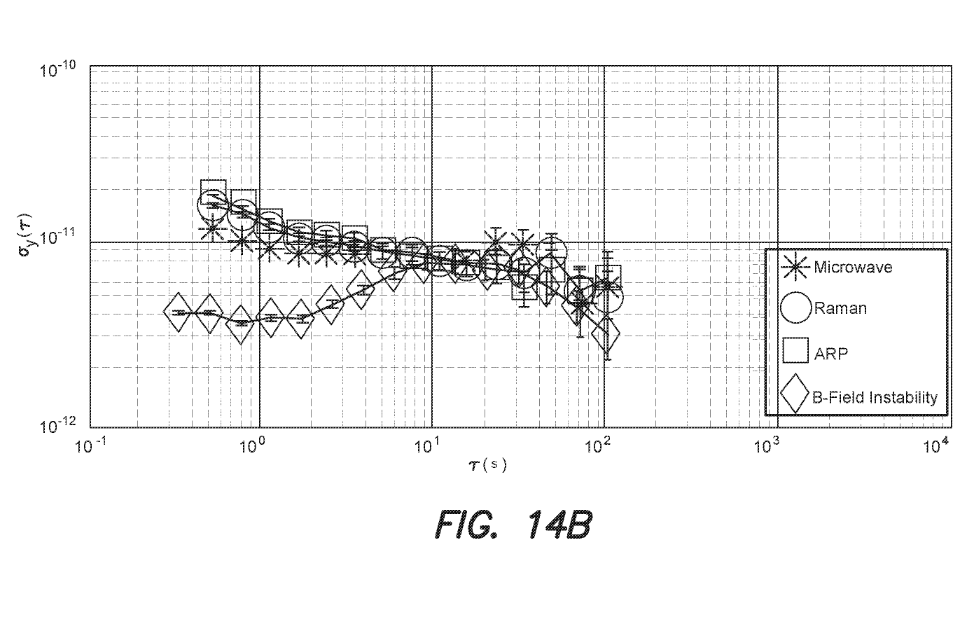

FIG. 14A plots the Allan deviations of the fractional frequency measurements that were acquired with the three interleaved pulse types. FIG. 14A indicates that the fractional frequency uncertainty for all interferometers was limited to ˜3.5×10⁻¹² around 2500 s. The similarity between the three responses indicates that light shifts were not the limiting systematic effect during the experiment. Magnetic-field instability was the dominant noise source for the unshielded apparatus used in the experiment, and limits long-term stability. This was confirmed with subsequent Ramsey interrogations of magnetically sensitive m_{F} states. Since Ramsey phase jitter was attributed to magnetic-field fluctuations, this was used to predict the instability in the clock resonance, which is shown as the diamonds, i.e., B-field instability, in FIG. 14A. At short averaging times from τ=10 to 100 s, the slopes of the Allan deviations indicate a white noise process driven largely by the low effective data rate. The stability measurements were repeated with a higher data rate of 5 Hz, which is a 38-fold increase in data rate), which improved the short-term stability of all pulse types to ˜1.5×10⁻¹¹ for an averaging time τ=1 s. Beyond τ=5 s, magnetic fields limited stability, and thus remained a source of long-term instability. Frequency measurements used for FIG. 14B were based on single shots acquired near quadrature phase, and the pulse types were not interleaved.

Aspects and embodiments of the present invention use frequency-swept Raman ARP as a tool for robust Ramsey interrogation, and various aspects of the present invention may be used to construct a compact primary frequency reference that is capable of operating in a dynamic environment.

As discussed herein, using a sufficiently adiabatic sweep produces Raman ARP Ramsey fringes that agree well with those of corresponding sequences based on Raman π/2 pulses. Raman ARP Ramsey sequences are shown to strongly suppress phase sensitivity to light shifts during the pulse. For example, for the small differential AC Stark shifts expected in a typical timing reference (i.e., |δ_{ac}|≦0.02Ω_{eff}), the phase sensitivity may be reduced by about two orders of magnitude, which effectively eliminates light shift contributions to short-term noise and improves prospects for long-term stability with an optical Ramsey interrogation. Various embodiments disclosed herein also reduce the sensitivity of Ramsey fringe contrast to Gaussian laser beam intensity gradients, which is critical to the function of cold atom clocks operating in dynamic environments. According to various aspects, the potential phase sensitivity to frequency sweep parameters may be below the resolution limits of the systems disclosed herein. Furthermore, single pulse experiments discussed herein indicated that the tangent frequency sweep characterized by Equation (1) is reproducible.

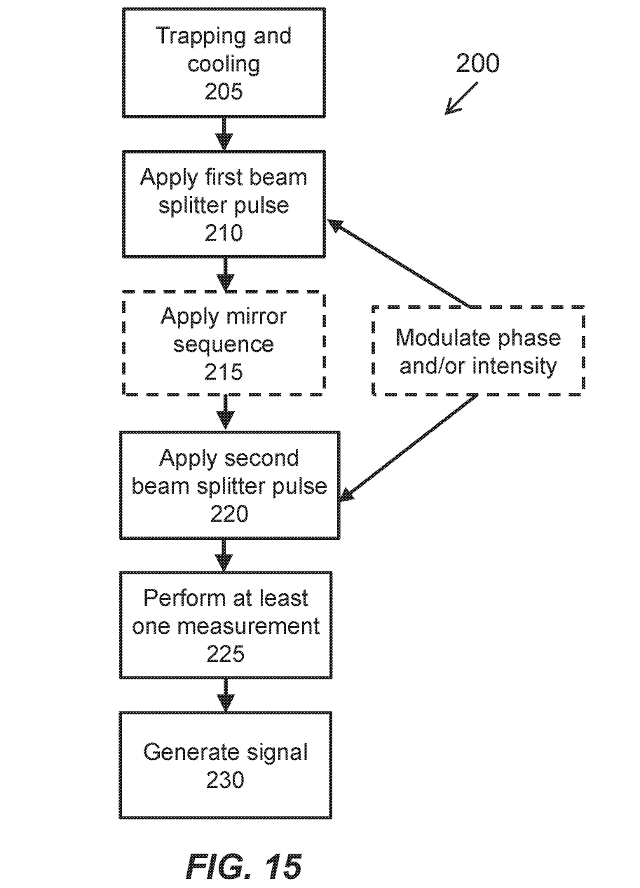

FIG. 15 is a flow diagram of at least one example of a method 200 according to one or more aspects of the systems and devices discussed above. At step 205, a cloud of atoms may be trapped and cooled to a predetermined temperature suitable for inertial sensing or atomic time-keeping, which in certain instances may be at least 9 micro-Kelvin. At step 210, a first beam splitter pulse may be applied to the cloud of atoms. After a first predetermined dwell time, a mirror sequence may be applied to the cloud of atoms (step 215), and after a second predetermined dwell time, a second beam splitter pulse sequence may be applied to the cloud of atoms (step 220). As indicated in FIG. 15, the mirror sequence may be optional, for example, in applications directed to atomic time-keeping the mirror sequence may not be necessary. According to some embodiments, at least one of the first and the second beam splitter pulse sequences is a π/2 adiabatic rapid passage (ARP) pulse sequence, and the mirror sequence may be a π ARP sequence. As indicated in FIG. 15, according to certain aspects, the phase and/or intensity of at least one of the first and the second beam splitter pulse sequences may be modulated. At step 225 at least one measurement may be performed during an interrogation time, and at step 230 a signal, such as a control signal, may be generated based on the at least one measurement. For example, the control signal may be used to control one or more operations in a navigation device or system, for example, in operations related to determining location. For instance, measurements related to acceleration or rotation sensing may be used to generate a control signal that is then used by a navigation device. In alternative embodiments, the signal generated at step 230 is a clock signal that may be used in applications directed to atomic time-keeping.

The aspects disclosed herein in accordance with the present invention, are not limited in their application to the details of construction and the arrangement of components set forth in the following description or illustrated in the accompanying drawings. These aspects are capable of assuming other embodiments and of being practiced or of being carried out in various ways. Examples of specific implementations are provided herein for illustrative purposes only and are not intended to be limiting. In particular, acts, components, elements, and features discussed in connection with any one or more embodiments are not intended to be excluded from a similar role in any other embodiments.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated reference is supplementary to that of this document; for irreconcilable inconsistencies, the term usage in this document controls. Moreover, titles or subtitles may be used in the specification for the convenience of a reader, which shall have no influence on the scope of the present invention.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

1. A method for inertial sensing, comprising:
trapping and cooling a cloud of atoms to a predetermined temperature;
applying a first beam splitter pulse sequence to the cloud of atoms;
after a first predetermined dwell time, applying a mirror sequence to the cloud of atoms subsequent to applying the first beam splitter pulse sequence;
after a second predetermined dwell time, applying a second beam splitter pulse sequence to the cloud of atoms subsequent to applying the mirror sequence;
modulating at least one of a phase and an intensity of at least one of the first and the second beam splitter pulse sequences;
performing at least one measurement subsequent to applying the second beam splitter pulse on the cloud of atoms during an interrogation time; and
generating a control signal based on the at least one measurement.

2. The method of claim 1, wherein at least one of the first and the second beam splitter pulse sequences is a π/2 adiabatic rapid passage (ARP) pulse sequence.

3. The method of claim 2, wherein the mirror sequence is a π ARP sequence.

4. The method of claim 1, wherein modulating includes nonlinear modulation of the phase.

5. The method of claim 1, wherein the at least one measurement is at least one of a measured transition probability and a fractional frequency measurement.

6. The method of claim 1, wherein the interrogation time is in a range from 1 to 17 ms.

7. A method for inducing momentum transfer, comprising trapping and cooling an atom cloud including a plurality of atoms;
applying a sequence of adiabatic rapid passage (ARP) light pulses to the plurality of atoms to induce momentum transfer, the sequence including:
applying a first π/2 ARP sweep;
after a first dwell time subsequent to the first π/2 ARP sweep, applying a mirror π ARP sweep; and
after a second dwell time subsequent to the mirror π ARP sweep, applying a second π/2 ARP sweep;
modulating at least one of a phase and an intensity of at least one of the first and the second π/2 ARP sweeps;
performing at least one measurement associated with induced momentum transfer of the atom cloud; and
generating a control signal based on the at least one measurement.

8. The method of claim 7, wherein the at least one measurement includes measuring at least one of an acceleration and a rotation of at least a portion of the plurality of atoms forming the atom cloud.

9. An atom interferometer, comprising:
an atom cloud including a plurality of atoms;
a trap configured to trap and cool the plurality of atoms to a predetermined temperature and launch the plurality of atoms into an interferometry region;
at least one laser light source disposed adjacent to the interferometry region and configured to apply a sequence of adiabatic rapid passage (ARP) light pulses to the interferometry region;
an electro-optic modulator coupled to the at least one laser light source and configured to sweep a Raman detuning frequency of the light pulses;
an amplifier coupled to the at least one laser light source and configured to modulate an optical intensity of the at least one laser light source; and
a controller coupled to the at least one laser light source, the electro-optic modulator, and the amplifier and configured to:
direct the sequence of ARP light pulses at the atom cloud to induce adiabatic transitions between internal quantum levels of at least a fraction of the plurality of atoms during the sequence of ARP light pulses; and
obtain at least one measurement from the atom cloud based on the adiabatic transitions.

10. The atom interferometer of claim 9, wherein the sequence of ARP light pulses comprises a first beam splitter pulse sequence, a mirror sequence, and a second beam splitter pulse sequence, the first beam splitter pulse sequence, the mirror sequence, and the second beam splitter pulse sequence temporally separated from one another by a dwell time, and the controller is further configured to control the timing of the sequence of ARP light pulses.

11. The atom interferometer of claim 10, wherein the at least one laser light source comprises counter-propagating beams of light directed at the atom cloud.

12. The atom interferometer of claim 11, wherein each beam of light is collimated to a 1/e² intensity diameter of 7.1 mm.

13. The atom interferometer of claim 9, wherein the sequence of ARP light pulses includes a first beam splitter pulse sequence and a second beam splitter pulse sequence temporally separated from one another by a dwell time.

14. The atom interferometer of claim 13, wherein the at least one laser light source comprises co-propagating beams of light.

15. The atom interferometer of claim 13, wherein the controller is further configured to generate a clock signal based on the at least one measurement.

16. The atom interferometer of claim 9, further comprising an arbitrary waveform generator coupled to the electro-optic modulator and configured to generate a phase waveform.

17. The atom interferometer of claim 9, further comprising a linear translation stage coupled to the at least one laser light source and configured to move the at least one laser light source in relation to the cloud of atoms in the interferometry region.

18. A method for atomic time-keeping, comprising:
trapping and cooling a cloud of atoms to a predetermined temperature;
applying a first beam splitter pulse sequence to the cloud of atoms;
after a first predetermined dwell time, applying a second beam splitter pulse sequence to the cloud of atoms subsequent to applying the first beam splitter pulse sequence;
modulating at least one of a phase and an intensity of at least one of the first and the second beam splitter pulse sequences;
performing at least one measurement on the cloud of atoms during an interrogation time following the second beam splitter pulse sequence; and
generating a clock signal based on the at least one measurement.

19. The method of claim 18, wherein at least one of the first and the second beam splitter pulse sequences is a π/2 adiabatic rapid passage (ARP) pulse sequence.

20. The method of claim 18, wherein the trapped and cooled cloud of atoms are in a first clock state and the at least one measurement includes determining a fraction of atoms in the first clock state and a fraction of atoms in a second clock state.
